(19) United States
(12) Patent Application Publication
(10) Pub. No.: US 2014/0244459 A1
(43) Pub. Date: Aug. 28, 2014

(54) MINIMUM AND MAXIMUM AMOUNTS OF RESOURCE CONSUMED BY DEVICE

(71) Applicant: HEWLETT-PACKARD DEVELOPMENT COMPANY, (US)

(72) Inventors: Rowdy K. Webb, Vancouver, WA (US); Kerry J. Kilk, Vancouver, WA (US); Jefferson P. Ward, Vancouver, WA (US)

(73) Assignee: HEWLETT-PACKARD DEVELOPMENT COMPANY, Fort Collins, CO (US)

(21) Appl. No.: 13/776,289

(22) Filed: Feb. 25, 2013

(51) Int. Cl. G06Q 30/04

(52) U.S. Cl. CPC G06Q 30/04
USPC 705/34

(57) ABSTRACT

A minimum amount is updated if a resource is consumed by the device before a corresponding timestamp. A maximum amount is updated only if a current timestamp is after the corresponding timestamp.

### BACKGROUND

User devices may subscribe to a service over a network from a provider. The service may allow the device to use a resource locally according to a subscription. Providers are challenged to provide their services in a reliable and uninterrupted manner to the user device over the network while accurately billing for subscription to the service.

### BRIEF DESCRIPTION OF THE DRAWINGS

The following detailed description references the drawings, wherein:

FIG. 1 is an example block diagram of a device for determining minimum and maximum amounts of a resource consumed by the device;

FIG. 2 is another example block diagram of a device for determining minimum and maximum amounts of a resource consumed by the device;

FIG. 3 is an example block diagram of a computing device including instructions for determining minimum and maximum amounts of a resource consumed by a device; and

FIG. 4 is an example flowchart of a method for determining minimum and maximum amounts of a resource consumed by a device.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Subscription to services over a network by user devices is becoming more prevalent with advances in technology. Such subscriptions may provide credits having a quantifiable value to the user device over the network in exchange for a periodic fee, such as a monthly fee. In turn, the user device may use the credits to buy and/or consume a local resource. For example, a provider may provide a printing service to a user device, such as a printer, where each credit may allow the printer to print a specified number of pages, such as 500 pages per credit. In this scenario, ink for the printer may be included in the subscription fee. For example, the provider may monitor ink levels at the printer and send new ink cartridges when ink levels become low, such as every 3 to 24 months. In one instance, the subscription may allow the user to print a fixed number of pages per month.

However, even though the subscription may allow the user to use a fixed amount of the resource per month, the user may need to use an additional amount of the resource beyond the fixed amount. For example, the provider may allow the user to print 100 pages per month. However, the user may need to print 120 pages in one month. Therefore, the provider may allow the user to print more than 100 pages per month but charge a different fee for the additional 20 pages, such as an overage fee for each page over the 100 pages.

Nonetheless, in certain circumstances, an exact time the resource is used may not be known. For example, the user device may usually provide a timestamp for when the resource is used. In the event that the user device does not know the current time and/or date (e.g. current timestamp), the user device may be unable to provide a timestamp for when the resource is used. For example, if the user device determines the timestamp though an internet connection but cannot connect to the internet when the resource is being consumed, the user device may be unable to provide the timestamp for when the resource was consumed.

In this case, the provider may not be able to accurately determine whether the resource was consumed in a current billing cycle or a next billing cycle. As a result, the provider may not be able to accurately bill the user, such as for overage fees. For example, the provider may allow the user to print 100 pages per month. The timestamps for first 80 pages may fall within a current billing cycle. However, timestamps may not be known for an additional 40 pages printed afterward. In this case, if all 40 pages were printed in the next billing cycle, there may no overage charges for the current billing cycle. On the other hand, if all 40 pages were printed in the current billing cycle, then the provider may desire to charge overage fess for the additional 20 pages printed beyond the 100 pages-per-cycle allowance. Simply assuming that all 40 pages were printed in the current billing cycle may lead to incorrect overage charges to the user. Further, the user dissatisfaction and complaints may increase and retention may decrease. Yet, assuming that all 40 pages were printed in the following month may lead to under-billing users and/or allow users to perpetrate fraud, such as by intentionally disconnecting the user device from the internet when using the resource to prevent overage fees.

Embodiments allow for provider to more accurately determine an amount of a resource used by a device during a time period, such as between two timestamps or within a billing cycle, without overbilling the user. For example, in one embodiment, a device may include a receiver unit, a counter, a timestamp unit and an output unit. The receiver unit may receive a packet from a provider over a network. The packet may include a plurality of timestamps. The counter may count a device total. The device total may indicate an amount of a resource consumed by the device over a life of a subscription to the resource. The timestamp unit may store a maximum amount of the device total and a minimum amount of the device total consumed up to each of the plurality of timestamps. The output unit may output the minimum and maximum amounts to the provider. The timestamp unit may update the minimum amount for a corresponding timestamp of the plurality of timestamps while a current timestamp is prior to the corresponding timestamp. The timestamp unit may update the maximum amount for the corresponding timestamp only once after the current timestamp is equal to or after the corresponding timestamp.

Thus, embodiments may be able to more accurately and/or confidently determine a minimum amount of the resource used during a given time period, without overbilling the user. Moreover, embodiments may do so independently of a frequency of communication between the provider and the device. Thus, the user of the device may not be inconvenienced.

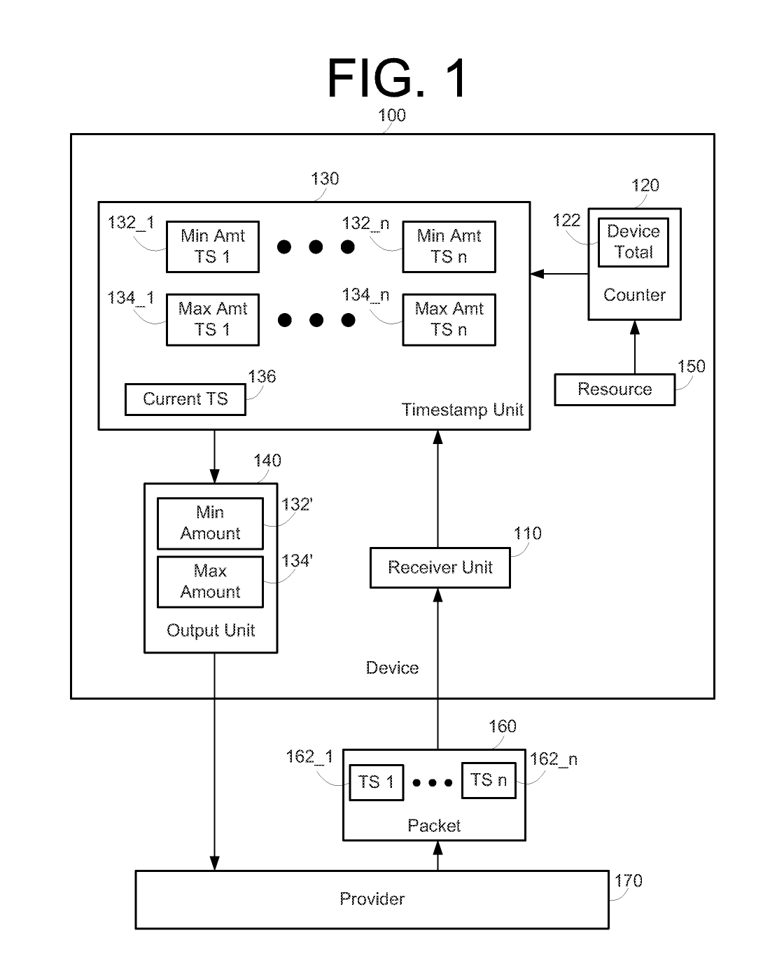

Referring now to the drawings, FIG. 1 is an example block diagram of a device 100 for determining minimum and maximum amounts 132′ and 134′ of a resource 150 consumed by the device 100. The device 100 may be any type of device capable of receiving a packet 160 over a network connection, such as a printer, fax machine, mobile device, computer, and the like. For example, the device 100 may include a memory (not shown) for storing data, the packet 160 and/or instructions and a processor (not shown) to execute instructions. The packet 160 may be any type of message sent over a network (not shown) by a provider 170 to the device 100.

The provider 170 may be any type of entity that provides a service, such as an application service provider (ASP), a network service provider (NSP), an internet service provider (ISP), a managed service provider (MSP), a storage service provider (SSP), a manufacturer of the subscription device 110, a telecommunications service provider (TSP), and the like. The term network may refer to any type of system capable of establishing a communication channel between two remote devices and/or entities, such as the device 100 and the provider 170. Examples of a type of the network may include a personal area network (PAN), a local area network (LAN), a home network, a storage area network (SAN), a campus network, a backbone network, a Metropolitan area network (MAN), a wide area network (WAN), an enterprise private network, a virtual private network (VPN), an Internetwork, and the like.

As explained above, the provider 170 may provide a subscription for a resource 140, with the packet 160 including an amount of the resource accumulated at a given time. Even though a single packet 160 is shown in FIG. 1, the provider 170 may provide a plurality of packets 160 over at different intervals of times, such as one packet 160 per day. The resource 150 may relate to any type of service and/or product being used by the device 100, such pages of paper, volume of ink, amount of time the device 100 may be on, a number of accesses allowed by the device 100 to content or a service, and the like. For instance, if the subscription relates to a monthly subscription for printing, the provider 170 may send the packet 160 every day to the device 100 indicating a total amount of pages available to the device 100 at the time the packet 160 is sent. For example, a first packet 160 may indicate 50 pages and a next packet may indicate 100 pages, and so on. The number of pages may continue to increase month-to-month, without resetting.

The device 100 is shown to include a receiver unit 110, a counter 120, a timestamp unit 130, an output unit 140 and a resource 150. The timestamp unit 130 may include, for example, a hardware device including electronic circuitry for implementing the functionality described below, such as control logic and/or memory. In addition or as an alternative, the timestamp unit 130 may be implemented as a series of instructions encoded on a machine-readable storage medium and executable by a processor. The receiver and output units 110 and 140 may include any type of hardware and/or protocols for interfacing with the network to receive the packet 160, such as network interface card (NIC). The counter 120 may be any type of device which stores a number of times a particular event or process has occurred.

The receiver unit 110 may receive the packet 160 from a provider 170 over the network (not shown). The packet 160 may include a plurality of timestamps 162_1 to 162_{—}n, where n is a natural number. The term timestamp may refer to a sequence of characters or encoded information identifying a date and/or time. Examples of timestamp formats may include the following: 2012-02-28 T 11:59 UTC; Thu Jan 31 11:59:59 2013; and 07:38, 11 December 2012 (UTC). For instance, the plurality of timestamps 162_1 to 162_{—}n may include the following dates, which coincide with an end of months: 2012-12-31 T 11:59 UTC; 2013-01-31 T 11:59 UTC; 2013-02-28 T 11:59 UTC; 2013-03-31 T 11:59 UTC; and 2013-04-30 T 11:59 UTC. Hence, in one embodiment, the plurality of timestamps 162_1 to 162_{—}n may be based on a division of time between billing cycles, such as monthly cycles, of the subscription to the resource 150.

The counter 120 may count a device total 122. The device total 122 may indicate an amount of the resource 150 consumed by the device 100 over a life of a subscription to the resource 150. The resource 150 may relate to, for example, pages, ink, time and accesses. While the resource 150 is shown to be internal to the device 100, embodiments of the device 100 may also have the resource 150 being external to the device 100.

The counter 120 may only count upward and the counter 120 may be encrypted and/or a secure device that is designed to be tamperproof. Thus, the device total 122 may not be resettable by the user and a likelihood of the device total 122 being fraudulently lowered may be reduced. Further, the packet 160 may include a digital signature to ensure its authenticity and/or be encrypted via an asymmetric key algorithm or hardware security module (HSM)-backed key pair.

For example, assuming the resource 150 being counted is pages printed, the device total 122 may be 500 if the user has printed 500 pages thus far over the life of the subscription. If the user then prints 50 more pages, the counter 120 may add 50 to the device total 122 such that the device total 122 is now 550. In one embodiment, the counter 120 may count the resource 150 before it is consumed by the device 100, such as by counting all the pages to be used for a spooled document. In another embodiment, the counter 120 may count the resource 150 after it is consumed by the device 100, such as by individually counting every page of a document after it is printed. While the counter 120 is shown external to the timestamp unit 130, the counter 120 may also be internal to the timestamp unit 130.

The timestamp unit 130 may store a maximum amount 134 of the device total 122 and a minimum amount 132 of the device total 122 consumed up to each of the plurality of timestamps 162_1 to 162_{—}n. For example, if the plurality of timestamps 162_1 to 162_{—}n include five timestamps, the timestamp unit 130 may include ten storage areas, such as ten registers. Five of the ten registers may store the minimum amounts 132_1 to 132_5 for a corresponding one of the five timestamps 162_1 to 162_5 and a remaining five of the ten registers may store maximum amounts 134_1 to 134_5 for the corresponding one of the five timestamps 162_1 to 162_5. Thus, the timestamp unit 130 may store a plurality of maximum and minimum amounts 132_1 to 132_{—}n and 134_1 to 134_{—}n of the device total 122, where n is a natural number, with each timestamp 162 corresponding to one of the minimum amounts 132 and one of maximum amounts 134.

The timestamp unit 130 may update the minimum amount 132, such as the first minimum amount 132_1, for a corresponding timestamp 162 of the plurality of timestamps 162, such as the first timestamp 162_1, while a current timestamp 136 is prior to the corresponding timestamp 162. For example, the first minimum and maximum amounts 132_1 and 134_1 may correspond to the first timestamp 162_1 and store an amount of the device total 122 consumed up to a date and/or time of the first timestamp 162_1. If the first timestamp 162_1 is 2012-12-31 T 11:59 UTC, the first minimum amount 132_1 may only be updated while the current timestamp is before 2012-12-31 T 11:59 UTC. The current timestamp 136 may a current time and/or date. For example, if the device 100 is powered on and connected to the network, the device 100 may be able to receive the current time and/or date and update the current timestamp 136 accordingly.

The timestamp unit 130 may update the maximum amount 134, such as the first maximum amount 134_1, for the corresponding timestamp 162, such as the first timestamp 162_1, only once after the current timestamp 136 is equal to or after the corresponding timestamp 162, such as the first timestamp 162_1. Further, the maximum and minimum amounts 132 and 134 may not be updated if the current timestamp 136 is not known. However, the maximum and minimum amounts 132 and 134 may be updated a next time the current timestamp 136 is known, if the current timestamp 136 is not known at a present time.

For example, assume the first timestamp 162_1 is 2012-12-31 T 11:59 UTC, and the current timestamp is before 2012-12-31 T 11:59 UTC. During this time, the first minimum amount 132-1 may be updated with the device total 122 any time the device total 122 is updated, such as when the resource 150 is consumed by the device 100. Then, assume the device 100 is unable to determine the current time and/or date, such as due to being powered down and/or unable to connect to the network. At this point, the current timestamp 136 is not known and thus none of the minimum and maximum amounts 132 and 134 may be updated, including the first maximum amount 1341. Now, at a next time the device 100 is able to determine the current time and/or date, assume the current timestamp 136 is 2013-01-03 T 02:33 UTC, which is after 2012-12-31 T 11:59 UTC, the first timestamp 162_1.

Here, the first minimum amount 132-1 may no longer be updated. The first maximum amount 134_1 may be updated by the device 122 only once after the device 100 discovers that the current timestamp 136 has passed the first timestamp 162_1, assuming that the first maximum amount 134_1 was not previously updated when the current timestamp 136 was equal to the first timestamp 162_1. Afterward, the first maximum amount 134_1 may not be updated again. If the current timestamp 136 had been known all along, both the first minimum amount 132_1 and the first maximum amount 1341 would have stopped being updated when the when the current timestamp 136 equaled the first timestamp 162_1. If the first minimum amount 132_1 and/or the first maximum amount 134_1 had never been updated to this point, then the timestamp unit 130 would update the first minimum amount 132_1 and/or the first maximum amount 134_1 at this point with the current device total 122.

Thus, the minimum amounts 132 may be updated each time the resource 150 is consumed by the device 100, the current timestamp 136 is known and the current timestamp 136 is prior to the corresponding timestamp 162. Also, the minimum amounts 132 may not to be updated if the current timestamp 162 is after the corresponding timestamp 162. For example, the timestamp unit 130 may stop updating minimum amounts 132, such as the first minimum amount 132_1, after the current timestamp 136 passes the corresponding timestamp, such as the first timestamp 162_1.

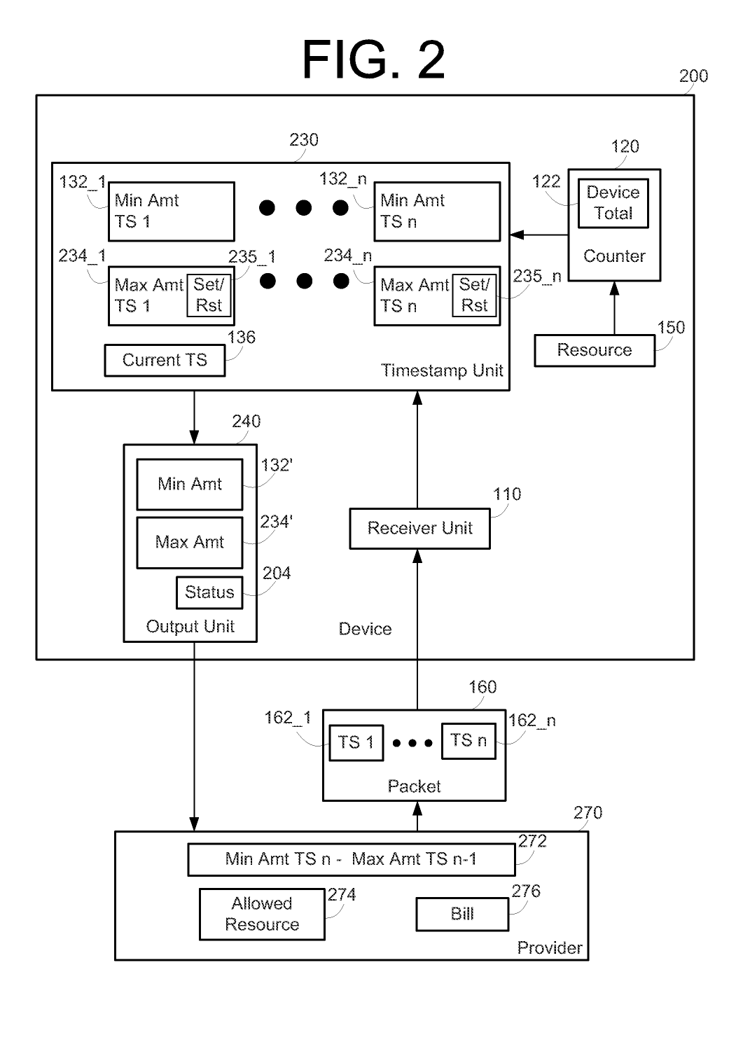

As a result of the above operations of the timestamp unit 130, the minimum amount 132, such as the first minimum amount 132_1, may not be higher than an actual amount of the resource 150 consumed by the device 100 for the corresponding timestamp 162, such as by the first timestamp 162_1. In addition, the maximum amount 134, such as the first maximum amount 134_1, may not be lower than the actual amount of the resource 150 consumed by the device 100 for the corresponding timestamp 162, such as the by first timestamp 162_1. The output unit 140 may output the minimum and maximum amounts 132′ and 134′ to the provider 170, as will be explained in further detail below with respect to FIG. 2.

FIG. 2 is another example block diagram of a device 200 for determining minimum and maximum amounts 132′ and 134′ of a resource 150 consumed by the device 200. The device 200 is shown to include the receiver unit 110, the counter 120, a timestamp unit 230, an output unit 240 and the resource 150. The device 200 of FIG. 2 may include at least the functionality and/or hardware of the device 100 of FIG. 1. For instance, the receiver unit 110, the counter 120, the timestamp unit 230, the output unit 240 and the resource 150 included in the device 200 of FIG. 2 may respectively include the functionality of the receiver unit 110, the counter 120, the timestamp unit 130, the output unit 140 and the resource 150 included in the device 100 of FIG. 1.

In FIG. 2, the timestamp unit 230 is shown to have a plurality of markers 235_1 to 235_{—}n associated with the plurality of maximum amounts 234_1 to 234_{—}n, where n is a natural number. The plurality of markers 235_1 to 235_{—}n may each represent, for example, a bit or flag that can be set and/or reset. The timestamp unit 230 may set the marker 235 after the corresponding maximum amount 234 is updated. The timestamp unit 230 may not further update the corresponding maximum amount 234 if the marker 235 is set. For example, the timestamp unit 230 may set the first marker 235_1 after it updates the first maximum amount 234_1. Afterward, the timestamp unit 230 may not further update the first maximum amount 234_1, as long the first marker 235_1 remains set.

The timestamp unit 230 may reset the corresponding marker 235 after a memory location (not shown), such as a register, storing the maximum amount 234 is to be repurposed for another of the plurality of timestamps 162 and/or another billing cycle of the subscription. The timestamp unit 230 may update the corresponding maximum amount 234 after the marker 235 is reset. The plurality of timestamps 162_1 to 162_{—}n may include at least one timestamp 162 prior to the current timestamp 136 and at least one timestamp 162 after the current timestamp 136. The output unit 240 may output the minimum and maximum amounts 132 and 234 to the provider 270 after the current timestamp 136 is after the corresponding timestamp 162 and/or when the device 200 provides a status 204 of the device 200 to the provider 270. That status 204 may be a periodic message and/or packet sent by the device 200 to the provider 270 including various information about the device 200, such as the amount of the resource 150 consumed or remaining, a health of the device 200 and the like.

For example, assume the packet 160 includes five timestamps having dates that fall at the end of December 2012, January 2013, February 2013, March 2013 and April 2013, where the current timestamp 136 falls sometime in the month of February 2013. The timestamp unit 230 may then include ten registers that store five minimum amounts 132_1 to 132_5 and five maximum amounts 234_1 to 234_5. The first and second minimum amounts 132_1 and 132_1 and the first and second maximum amounts 234_1 and 234_2 may correspond to dates, such as the end of December 2012 and January 2013, that are prior to the current timestamp 136 and no longer being updated by the timestamp unit 230.

Thus, the output unit 240 may output the first and second minimum amounts 132_1 and 132_1 and the first and second maximum amounts 234_1 and 234_2 to the provider 270, either separately from or concurrently with the status 204. Moreover, since the first and second minimum amounts 132_1 and 132_2 and the first and second maximum amounts 234_1 and 234_2 have been output to the provider 270, the timestamp unit 230 may reuse/repurpose the registers corresponding to first and second minimum amounts 132_1 and 132_2 and the first and second maximum amounts 234_1 and 234_2, such as for new timestamps 162 arriving on a next packet 160 from the provider 270. As a result, the timestamp unit 230 may also reset the first and second markers 235_1 and 235_2 that corresponded to the first and second maximum amounts 234_1 and 234_2.

The provider 270 may subtract the maximum amount 234_{—}n−1 corresponding to an earlier timestamp 162_n−1 of the plurality of timestamps 162_1 to 162_{—}n from a minimum amount 162_{—}n corresponding to a later timestamp 162_{—}n of the plurality of timestamps 162_1 to 162_{—}n, to determine the amount of the resource consumed from the earlier timestamp to the later timestamp 272 by the device 200. The above subtraction may provide a conservative estimate of the amount of the resource 150 consumed from the earlier timestamp 162_{—}n−1 to the later timestamp 162_{—}n, such as when an exact timestamp is unknown for at least some the resources 150 consumed this timestamp may fall between two billing periods, such as before or after the later timestamp 162_{—}n. For example, in order to determine the amount of the resource consumed for the month of February 2013, the second maximum amount 234_2 (corresponding to the end of January 2013) may be subtracted from the third minimum amount 132_3 (corresponding to the end of February 2013).

Next, the provider 270 may compare the amount of the resource consumed from the earlier timestamp to the later timestamp 272 by the device 200 to an amount of the resource allowance 274 to the device 200 by the provider 270 between the earlier and later timestamps 162_{—}n−1 to 162_{—}n. The provider 270 may determine an amount to bill 276 the user of the device 200 for use of the resource 150 based on this comparison. For example, if the above subtraction determines that the user consumed 120 pages from the earlier timestamp 162_{—}n−1 to the later timestamp 162_{—}n, but only 100 pages had been allowed between the earlier and later timestamps 162_{—}n−1 to 162_{—}n, according to the subscription, then the provider 270 may calculate the bill 276 so to include overage charges for the additional 20 pages consumed.

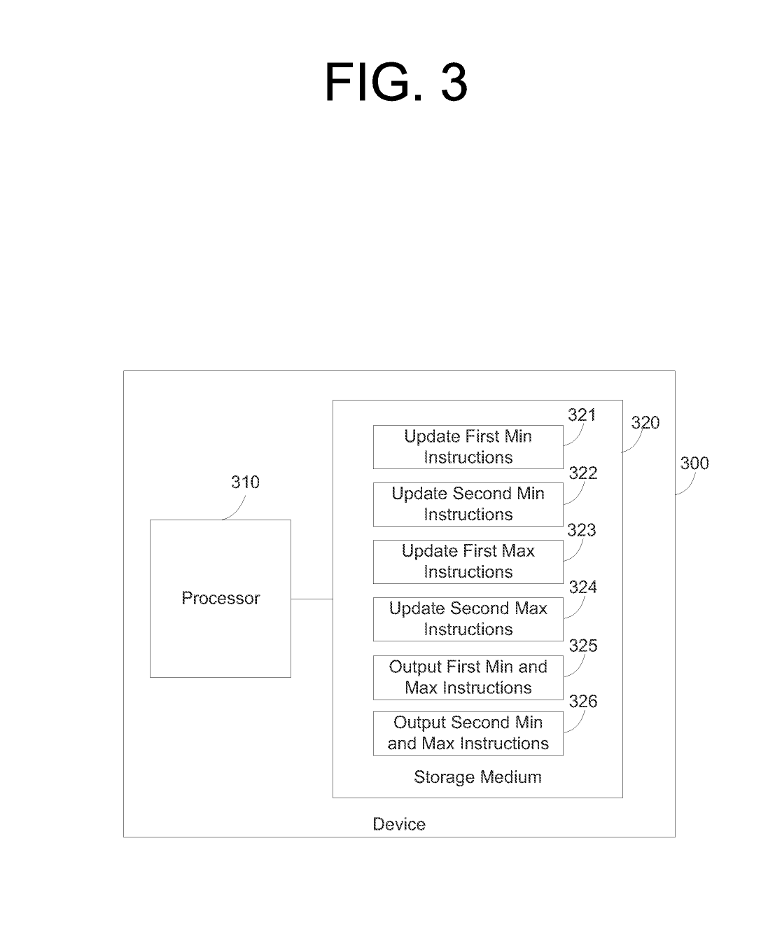

FIG. 3 is an example block diagram of a computing device 300 including instructions for determining minimum and maximum amounts of a resource consumed by a device. In the embodiment of FIG. 3, the computing device 300 includes a processor 310 and a machine-readable storage medium 320. The machine-readable storage medium 320 further includes instructions 321 to 326 for determining the minimum and maximum amounts of the resource (not shown) consumed by the device.

The computing device 300 may be, for example, a printer, a mobile device, a fax machine, multimedia device, a secure microprocessor, a notebook computer, a desktop computer, an all-in-one system, a server, a network device, a controller, a wireless device, or any other type of device capable of executing the instructions 321 to 326. In certain examples, the computing device 300 may include or be connected to additional components such as memories, controllers, etc.

The processor 310 may be, at least one central processing unit (CPU), at least one semiconductor-based microprocessor, at least one graphics processing unit (GPU), a microcontroller, special purpose logic hardware controlled by microcode or other hardware devices suitable for retrieval and execution of instructions stored in the machine-readable storage medium 320, or combinations thereof. The processor 310 may fetch, decode, and execute instructions 321 to 326 to implement determining the minimum and maximum amounts of the resource consumed by the device. As an alternative or in addition to retrieving and executing instructions, the processor 310 may include at least one integrated circuit (IC), other control logic, other electronic circuits, or combinations thereof that include a number of electronic components for performing the functionality of instructions 321 to 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for determining the minimum and maximum amounts of the resource consumed by the device.

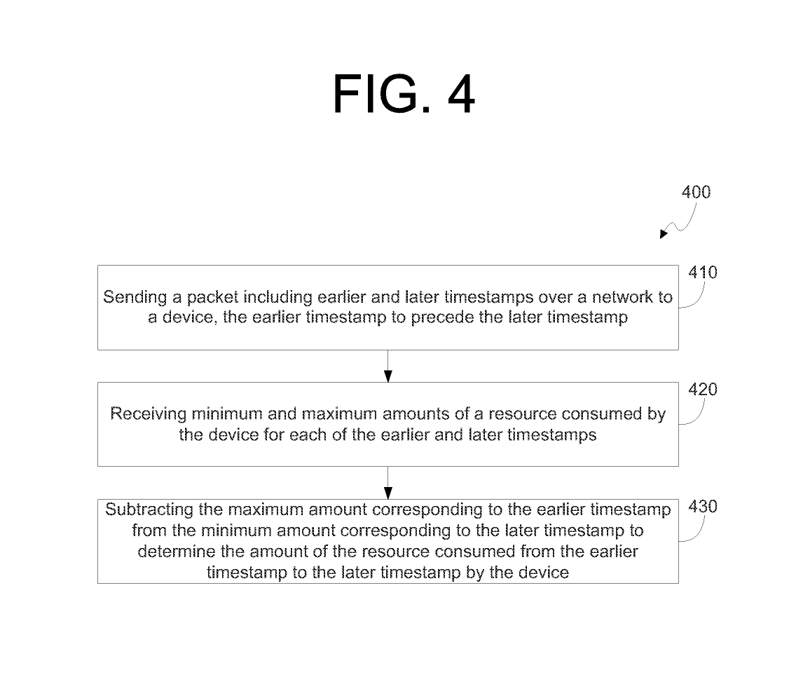

Moreover, the instructions 321 to 326 when executed by a processor (e.g., via one processing element or multiple processing elements of the processor) can cause the processor to perform processes, such as, the process of FIG. 4. For example, the update first minimum instructions 321 may be executed by the processor 310 to update a first minimum amount if a resource is consumed by the device before a first timestamp. The update second minimum instructions 322 may be executed by the processor 310 to update a second minimum amount if the resource is consumed by the device before a second timestamp. The update first maximum instructions 323 may be executed by the processor 310 to update a first maximum amount only once if a time the resource is consumed is not known and a current timestamp is after the first timestamp.

The update second maximum instructions 324 may be executed by the processor 310 to update a second maximum amount only once if the time the resource is consumed is not known and the current timestamp is after the second timestamp. The output first minimum and maximum instructions 325 may be executed by the processor 310 to output the first minimum and maximum amounts to a provider over a network after the first timestamp. The output second minimum and maximum instructions 326 may be executed by the processor 310 to output the second minimum and maximum amounts to the provider over the network after the second timestamp. The provider may subtract the first maximum amount from the second minimum amount to determine the amount of the resource consumed from the first timestamp to the second timestamp by the device.

FIG. 4 is an example flowchart of a method 400 for determining minimum and maximum amounts of a resource consumed by a device. Although execution of the method 400 is described below with reference to the provider 270, other suitable components for execution of the method 400 can be utilized, such as the provider 170. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the provider 270 sends a packet 162 including earlier and later timestamps 162 over a network to a device 200. The earlier timestamp 162 is to precede the later timestamp 162. Next, at block 420, the provider 270 receives the minimum and maximum amounts 132′ and 134′ of a resource 150 consumed by the device 200 for each of the earlier and later timestamps 162. The minimum amounts 132′ of the earlier and later timestamps 162 may only be updated before the receiving at block 420, if the resource 150 is consumed by the device 200 prior to the corresponding earlier and later timestamps 162. The maximum amounts 134′ of the earlier and later timestamps 162 are only updated up to once before the receiving at block 420, if the resource 150 is consumed by the device 200 at an unknown time having a range that is equal to after the corresponding earlier and later timestamps 162.

Then, at block 430, the provider 270 subtracts the maximum amount corresponding to the earlier timestamp from the minimum amount corresponding to the later timestamp 272 to determine the amount of the resource 150 consumed from the earlier timestamp 162 to the later timestamp 162 by the device 200. An amount to bill 276 to a user of the device 200 for use of the resource 150 may be based on a difference 272 between the amount of the resource 150 consumed from the earlier timestamp 162 to the later timestamp 162 by the device 200 and an amount of the resource allotted 274 to the device 200 between the earlier and later timestamps 162.

According to the foregoing, embodiments provide a method and/or device for allowing a provider to more accurately determine an amount of a resource used by a device during a time period, such as between two timestamps or within a billing cycle. For example, a provider may able to securely determine a minimum amount of the resource used during a given time period, without frequently contacting the device for information.

We claim:

1. A device, comprising:
a receiver unit to receive a packet from a provider over a network, the packet to include a plurality of timestamps;
a counter to count a device total, the device total to indicate an amount of a resource consumed by the device over a life of a subscription to the resource;
a timestamp unit to store a maximum amount of the device total and a minimum amount of the device total consumed up to each of the plurality of timestamps; and
an output unit to output the minimum and maximum amounts to the provider, wherein
the timestamp unit is to update the minimum amount for a corresponding timestamp of the plurality of timestamps while a current timestamp is prior to the corresponding timestamp, and
the timestamp unit is to update the maximum amount for the corresponding timestamp only once after the current timestamp is equal to or after the corresponding timestamp.

2. The device of claim 1, wherein,
the maximum and minimum amounts are not updated if the current timestamp is not known, and
the maximum and minimum amounts are updated a next time the current timestamp is known, if the current timestamp is not known at a present time.

3. The device of claim 1, wherein,
the minimum amount is updated each time the resource is consumed by the device, the current timestamp is known and the current timestamp is prior to the corresponding timestamp, and
the minimum amount is not to be updated if the current timestamp is equal to or after the corresponding timestamp.

4. The device of claim 1, wherein,
the timestamp unit is to stop updating minimum amount after the current timestamp passes the corresponding timestamp,
the output unit is to output the minimum and maximum amounts to the provider after the current timestamp is after the corresponding timestamp, and
the output unit is to output the minimum and maximum amounts to the provider when the device provides a status of the device to the provider.

5. The device of claim 4, wherein,
the provider is to subtract the maximum amount corresponding to an earlier timestamp of the plurality of timestamps from a minimum amount corresponding to a later timestamp of the plurality of timestamps to determine the amount of the resource consumed from the earlier timestamp to the later timestamp by the device, and
the earlier timestamp precedes the later timestamp.

6. The device of claim 5, wherein,
the provider is to compare the amount of the resource consumed from the earlier timestamp to the later timestamp by the device to an amount of the resource allowance to the device by the provider between the earlier and later timestamps, and
the provider is to determine an amount to bill to a user of the device for use of the resource based on the comparison.

7. The device of claim 1, wherein,
the timestamp unit is to set a marker after the maximum amount is updated, and
the timestamp unit is to not update the maximum amount if the marker is set.

8. The device of claim 7 wherein,
the timestamp unit is to reset the marker after a memory location storing the maximum amount is to be repurposed for at least one of another of the plurality of timestamps and another billing cycle of the subscription, and
the timestamp unit is to update the maximum amount if the marker is reset.

9. The device of claim 1, wherein,
the plurality of timestamps includes at least one timestamp prior to the current timestamp and at least one timestamp after the current timestamp, and
the plurality of timestamps is based on a division of time between billing cycles of the subscription to the resource.

10. The device of claim 1, wherein,
the minimum amount is to not be higher than an actual amount of the resource consumed by the device for the corresponding timestamp, and
the maximum amount is to not be lower than the actual amount of the resource consumed by the device for the corresponding timestamp.

11. The device of claim 1, wherein,
the resource relates to at least one of pages, ink, time and accesses,
the counter is to only count upward, and
the counter is at least one of encrypted and a secure device.

12. A method, comprising:
sending a packet including earlier and later timestamps over a network to a device, the earlier timestamp to precede the later timestamp;
receiving minimum and maximum amounts of a resource consumed by the device for each of the earlier and later timestamps; and
subtracting the maximum amount corresponding to the earlier timestamp from the minimum amount corresponding to the later timestamp to determine the amount of the resource consumed from the earlier timestamp to the later timestamp by the device, wherein
the minimum amounts of the earlier and later timestamps are only updated before the receiving, if the resource is consumed by the device prior to the corresponding earlier and later timestamps, and
the maximum amounts of the earlier and later timestamps are only updated up to once before the receiving, if the resource is consumed by the device at an unknown time having a range that is equal to after the corresponding earlier and later timestamps.

13. The method of claim 12, wherein an amount to bill to a user of the device for use of the resource is based on a difference between the amount of the resource consumed from the earlier timestamp to the later timestamp by the device and an amount of the resource allotted to the device between the earlier and later timestamps.

14. A non-transitory computer-readable storage medium storing instructions that, if executed by a processor of a device, cause the processor to:
update a first minimum amount if a resource is consumed by the device before a first timestamp;
update a second minimum amount if the resource is consumed by the device before a second timestamp;
update a first maximum amount only once if a time the resource is consumed is not known and a current timestamp is after the first timestamp;
update a second maximum amount only once if the time the resource is consumed is not known and the current timestamp is after the second timestamp;
output the first minimum and maximum amounts to a provider over a network after the first timestamp; and
output the second minimum and maximum amounts to the provider over the network after the second timestamp.

15. The non-transitory computer-readable storage medium of claim 14, wherein the provider is to subtract the first maximum amount from the second minimum amount to determine the amount of the resource consumed from the first timestamp to the second timestamp by the device.
